(19) United States
(12) Patent Application Publication
(10) Pub. No.: US 2018/0195477 A1
(43) Pub. Date: Jul. 12, 2018

(54) VALVE FOR METERING A FLUID

(71) Applicant: Robert Bosch GmbH, Stuttgart (DE)

(72) Inventors: Andreas SCHAAD, Maulbronn (DE); Joerg ABEL, Gerlingen (DE); Juergen Maier, Ottmarsheim (DE); Martin Buehner, Backnang (DE); Matthias Boee, Ludwigsburg (DE); Olaf Schoenrock, Stuttgart-Weilimdorf (DE); Philipp Rogler, Stuttgart (DE); Stefan Cerny, Bietigheim-Bissingen (DE)

(21) Appl. No.: 15/742,318

(22) PCT Filed: Jun. 17, 2016
(86) PCT No.: PCT/EP2016/063975

§ 371 Date: Jan. 5, 2018

(30) Foreign Application Priority Data
Jul. 15, 2015 (DE) 10 2015 213 221.8

(51) Int. Cl. F02M 51/06

(52) U.S. Cl. CPC F02M 51/0685; F02M 2200/306; F02M 2200/304; F02M 2200/302

(57) ABSTRACT

A valve for metering a fluid, the valve preferably being designed as a fuel injector for internal combustion engines. The valve includes an electromagnetic actuator and a valve needle that is actuatable by the actuator. The valve needle is used for actuating a valve closing body that cooperates with a valve seat surface to form a sealing seat. An armature of the actuator includes a through opening through which the valve needle extends. An annular gap is formed between an inner wall of a housing part and an outer side of the armature. A movable damping element that may have a partial ring shape is situated on the annular gap. The movable damping element is actuatable by a magnetic field that is generated by the actuator. The dynamics of the armature may thus be advantageously influenced in order to in particular reduce an armature bounce.

### FIELD

The present invention relates to a valve for metering a fluid, in particular a fuel injector for internal combustion engines. In particular, the present invention relates to the field of injectors for fuel injection systems of motor vehicles, in which preferably a direct injection of fuel into combustion chambers of an internal combustion engine takes place.

### BACKGROUND INFORMATION

A fuel injector is described in German Patent Application No. DE 103 60 330 A1 which is used in particular for fuel injection systems of internal combustion engines. The conventional fuel injector includes a valve needle that cooperates with a valve seat surface to form a sealing seat. In addition, an armature that is acted on by a return spring in a closing direction is connected to the valve needle, an actuation of the armature being possible via a solenoid. The armature is situated in a recess in an external pole of the magnetic circuit. A collar having a triangular cross section is provided around the circumference of the armature. Directionally dependent hydraulic damping of the armature is possible due to the shape of the collar. Damping of the opening movement takes place, resulting in a virtually unhindered flow of fuel during the closing movement, so that the fuel injector may be quickly closed.

### SUMMARY

An example valve according to the present invention have the advantage that an improved design and functionality are made possible. In particular, improved multiple injection capability with short pause times may be achieved with a design having an armature free travel path.

Advantageous refinements of the valve set in accordance with the present invention are possible due to the measures described herein.

In the example valve for metering the fluid, the armature, which is used as a solenoid armature, is not fixedly connected to the valve needle, but instead is freely suspended between the stops. Such stops may be implemented by stop sleeves and/or stop rings. The armature in the neutral state is moved, via a return spring, against a stop that is stationary with respect to the valve needle, so that the armature rests there. During the control of the valve, the entire armature free travel path is then available as an acceleration path. The axial play between the solenoid armature and the two stops may be referred to as the armature free travel path.

Compared to a fixed connection of the armature to the valve needle, this results in the advantage that, due to the resulting pulse of the armature during opening, with the same magnetic force, the valve needle may be reliably opened, also at higher pressures, in particular fuel pressures. This may be referred to as dynamic mechanical reinforcement. Another advantage is that decoupling of the involved masses takes place, so that the resulting stop forces on the sealing seat are split into two pulses.

However, specific problems arise that are associated with the free suspension of the armature on the valve needle. When the valve closes, the armature may bounce back after striking the stop in question, and in the extreme case the entire armature free travel path may be traversed again, and the next time the armature strikes the oppositely situated stop, the armature still has so much energy that the valve needle is briefly lifted from its seat once again. An inadvertent post-injection may thus occur, resulting in increased fuel consumption and possibly increased pollutant emissions. Even if the armature does not traverse the entire armature free travel path when it bounces back, it may take some time before the armature is calmed and returns into the starting position. If re-actuation now takes place before the final calming, which is important in particular for multiple injections with short pause times between the injections, a robust valve function is not possible. For example, the stop pulses may correspondingly increase or decrease, which in the worst case may result in the valve no longer opening at all, since the stop pulse is no longer large enough for this purpose.

Due to the damping element, it is advantageously possible for the armature (solenoid armature) to be suitably decelerated, which preferably takes place during the closing operation. An armature bounce may thus be prevented or at least reduced. A more robust multiple injection capability with short pause times may be achieved as a result. In addition, smaller stop pulses may be achieved during closing, which reduces the wear on the armature and the stops, and also on the valve seat. Noise may also be reduced in this way. There are also fewer changes in functioning over the service life. Bouncing back of the valve needle, designed as a needle pin, for example, and/or of the armature during closing may thus be reduced. In addition, the armature may be placed back into its neutral position more quickly. The risk of needle or armature bounces, which result in inadvertent post-injections, is thus likewise reduced.

One or more significant advantages or particular properties may thus be achieved, depending on the design of the valve. A directionally dependent deceleration or damping of the axial armature movement may be achieved. An acceleration of the armature without friction between the armature and the damping element may thus be made possible in order to achieve a rapid pulse buildup and thus ensure reliable opening of the valve. The deceleration of the armature may take place with the aid of fluid damping and/or friction during the closing operation, resulting in smaller stop pulses, quicker calming of the armature movement, and lower noise emissions.

The valve closing body that is actuated by the valve needle may be designed in one piece with the valve needle. Suitable designs of the valve closing body are thus possible. In particular, the valve closing body may be designed as a spherical or partially spherical valve closing body.

Since the movable damping element is actuated by the magnetic field generated by the actuator, a movement of the damping element that corresponds to the increasing and once again dissipating magnetic field is advantageously possible.

An example embodiment may have the advantage that the actuation of the damping element and a resulting effect on the movement behavior of the armature are optimized. In particular, a rapid change in the free annular gap may be achieved in order to correspondingly quickly influence the hydraulic damping. In addition, the effect of friction forces may be reduced.

Another example embodiment may have the advantage that the free cross section of the annular gap may advantageously be enlarged when the armature is released. As a result of the indentation completely accommodating the damping element, the entire annular gap may also be available for a largely unthrottled fluid exchange, which significantly reduces the hydraulic damping compared to the unactuated state. The embodiment according to claim 4 has the further advantage that the indentation used for accommodating the damping element is at the same time available for accommodating one or multiple spring elements that bring the damping element into its starting position when the magnetic field dissipates.

In addition, the indentation may at the same time be used for radially guiding the damping element, which is advantageously possible in particular for a grooved indentation. Further advantages thus result when one or multiple embodiments according to claim 5 are implemented.

A refinement in accordance with the present invention may have the advantage that damping is achievable due to a friction force between the damping element and the outer side of the armature, which may optionally take place in addition to the hydraulic damping due to a fluid exchange that is based on a displacement principle. Depending on the fluid, in particular its viscosity, sufficient damping with a small spacing between the damping element and the outer side of the armature may already result due to the throttling.

In one advantageous refinement according to the present invention, in particular a formation of the damping element from two components may be achieved. A pairing of a ferromagnetic material with a paramagnetic material is particularly advantageous. It is thus possible, among other things, for the damping element to not magnetically adhere to the armature, which would delay the detachment from the armature. In addition, in the pairing with the armature the paramagnetic material may advantageously be optimized with regard to its friction properties.

Another example embodiment of the present invention may have the advantage that, due to its geometric design, the damping element may have a resilient configuration. The magnetic force may then work against the spring that is formed by the damping element in order to spread the damping element apart. Additional spring elements may thus be dispensed with, or at least dimensioned smaller with regard to their elastic force. In addition, the partial ring-shaped design has the advantage of a large circumferential extension, resulting in optimized influencing of the free annular gap.

According to another embodiment of the present invention, influencing preferably takes place during closing of the valve needle, in that damping is hereby achieved via the damping element.

### BRIEF DESCRIPTION OF THE DRAWINGS

Preferred exemplary embodiments of the present invention are explained in greater detail in the following description with reference to the figures, in which corresponding elements are provided with the same reference numerals.

FIG. 1 shows a valve in a partial schematic sectional illustration corresponding to a first exemplary embodiment of the present invention.

FIG. 2 shows the detail of the valve according to the first exemplary embodiment denoted by reference numeral II in FIG. 1, in a detailed illustration in a starting state.

FIG. 3 shows a flow chart for explaining the operating principle of the valve according to the first exemplary embodiment of the present invention.

FIG. 4 shows the detail of the valve according to a second exemplary embodiment of the present invention denoted by reference numeral IV in FIG. 1, in a schematic illustration in a starting state.

FIG. 5 shows a section of the valve according to the second exemplary embodiment, along the section line denoted by reference numeral V in FIG. 4.

### DETAILED DESCRIPTION OF EXAMPLE EMBODIMENTS

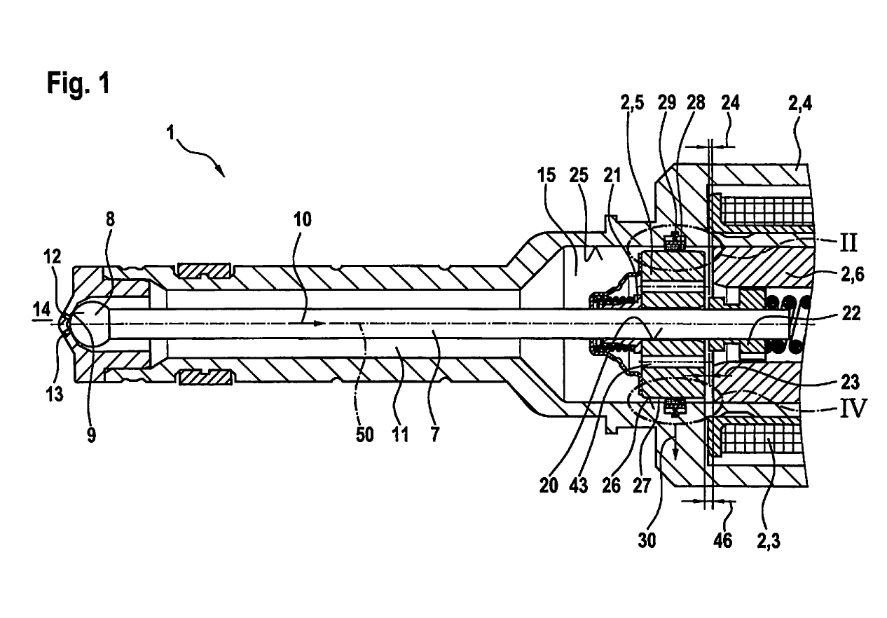

FIG. 1 shows a valve 1 for metering a fluid in a partial schematic sectional illustration corresponding to a first exemplary embodiment. Valve 1 may be designed in particular as a fuel injector 1. One preferred application is a fuel injection system in which such fuel injectors 1 are designed as high-pressure injectors 1 and used for direct injection of fuel into associated combustion chambers of the internal combustion engine. Liquid or gaseous fuels may be used as fuel.

Valve 1 includes an actuator 2 that includes a solenoid 3, a ferromagnetic housing part 4, an armature (solenoid armature) 5, and a ferromagnetic internal pole 6. A valve needle 7 that is in turn used for actuating a valve closing body 8, which in this exemplary embodiment is spherical, is actuatable via actuator 2. Valve closing body 8 cooperates with a valve seat surface 9 to form a sealing seat. For opening valve 1, valve needle 7 is actuated in an opening direction 10 so that the sealing seat is opened, and fuel or some other fluid is injectable or blowable from an inner chamber 11 via spray holes 12, 13 into a suitable chamber 14, in particular a fuel chamber 14. In this exemplary embodiment, an inner chamber 15 in which armature 5 is situated communicates with inner chamber 11. However, in one modified embodiment, inner chamber 15 may also be separate from inner chamber 11 into which the fluid to be injected or blown is provided. This is possible in particular for gaseous fluids in order to fill inner chamber 15 with some other, preferably liquid, fluid for damping.

Armature 5 of actuator 2 includes a through opening 20 through which valve needle 7 extends. Armature 5 is displaceably situated on valve needle 7. This displaceability is limited by stop elements 21, 22 that are stationarily fastened to valve needle 7. Lower stop 21 in this exemplary embodiment is designed as a stop sleeve 21, and upper stop 22 in this exemplary embodiment is designed as a stop ring 22. The play that is hereby achieved allows an armature free travel path 23. In addition, due to a distance 24 from internal pole 6 that adjoins armature free travel path 23, a lift 24 results, via which a movement of valve needle 7 is possible. In this exemplary embodiment, internal pole 6 forms an end stop during the actuation of armature 5.

An annular gap 27 is formed between an inner wall 25 of housing part 4 and an outer side 26 of armature 5. A movable damping element 28, which in this exemplary embodiment is acted on by a spring element 29 in the direction of outer side 26 of armature 5, is situated on annular gap 27.

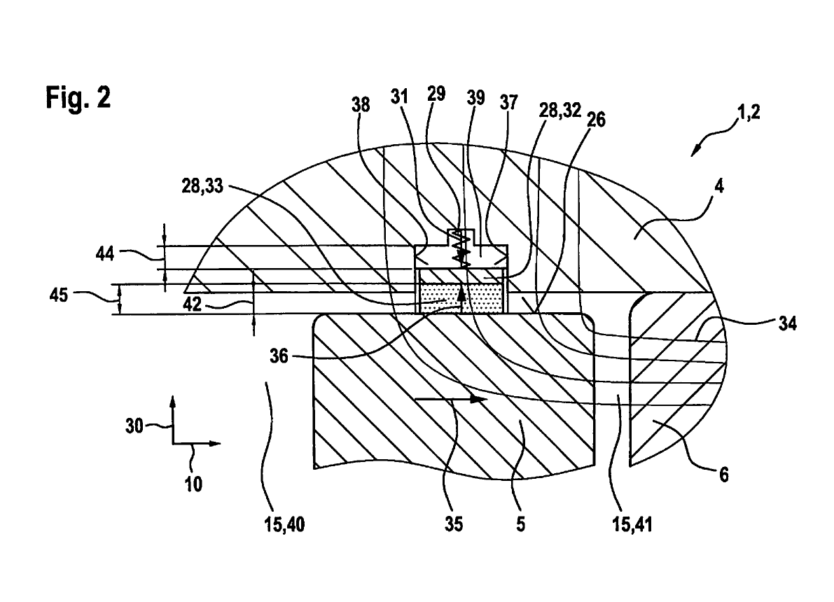

Movable damping element 28 is actuatable by the magnetic field that is generatable by actuator 2. An actuation of movable damping element 28 in radial direction 30 is thus possible. The design of the valve according to the first exemplary embodiment is explained in greater detail below, also with reference to FIG. 2.

FIG. 2 shows the detail of valve 1 in the first exemplary embodiment, denoted by reference numeral II in FIG. 1, in a detailed illustration in a starting state. FIG. 2 illustrates opening direction 10 and a radial direction 30, perpendicular to opening direction 10, as one possible reference system for explaining the operating principle. It is understood that radial direction 30 represents a radial direction 30 by way of example. In particular, multiple repetitions of this design in various radial directions 30 that are perpendicular to opening direction 10 are possible. Spring element 29 is pretensioned in such a way that a certain action of damping element 28 opposite to radial direction 30 takes place. This is depicted by a force arrow 31 that is oriented opposite to radial direction 30. When no magnetic field prevails, force 31 presses damping element 28 against outer side 26 of armature 5, thus generating a friction force. In this exemplary embodiment, damping element 28 is formed from two components, namely, partially from a ferromagnetic material 32 and partially from a paramagnetic material 33.

Ferromagnetic material 32 may be based on a ferritic steel, for example. Paramagnetic material 33 may be based, for example, on an austenitic steel, a plastic, or a ceramic. Paramagnetic material 33 rests against outer side 26 and allows damping due to friction. Ferromagnetic material 32 is separate from outer side 26, so that a magnetic adhesive effect during actuation of damping element 28 is prevented.

A magnetic field is generated during an energization of solenoid 3. An axial magnetic force 35 that acts on armature 5, and a radial magnetic force 36 that acts on damping element 28, are generated due to this magnetic field, which is depicted by magnetic field lines 34. Radial magnetic force 36 arises due to the action of magnetic field lines 34 on ferromagnetic material 32 of damping element 28. Guiding of damping element 28 in radial direction 30 is ensured by side walls 37, 38 of a grooved indentation 39 in which damping element 28 is at least partially situated.

When radial magnetic force 36 exceeds elastic force 31 of spring element 29, damping element 28 detaches from outer side 26, thus eliminating the friction force in this regard. This preferably takes place comparatively early during the control, and thus at the beginning of the movement of armature 5 in opening direction 10.

Inner chamber 15 includes subchambers 40, 41 that are provided on both sides of armature 5. Via a fluid exchange between subchambers 40, 41, hydraulic damping may be achieved in addition to the friction-based damping. For this purpose, a radial extension 42 of annular gap 27 is specified in such a way that, without damping element 28, a fluid exchange that is essentially unthrottled with regard to the dynamics of armature 5 is possible. This may be assisted by one or multiple coaxial through holes 43, of which through hole 43 is denoted by way of example in FIG. 1.

The free cross section of annular gap 27 is reduced by introducing damping element 28 into annular gap 27, so that the hydraulic throttling effect increases. Taking through holes 43 into account, this results in a coordinated design in such a way that significant throttling of the fluid exchange between subchambers 40, 41 with regard to armature 5 is possible when the free cross section of annular gap 27 is reduced by one or multiple damping elements 28. This also results in hydraulic damping of armature 5.

In one modified embodiment, instead of direct friction between damping element 28 and outer side 26 of armature 5, an approach up to a minimum distance may be provided, so that sufficient hydraulic damping already takes place due to the viscosity of the fluid, and direct friction may thus be unnecessary.

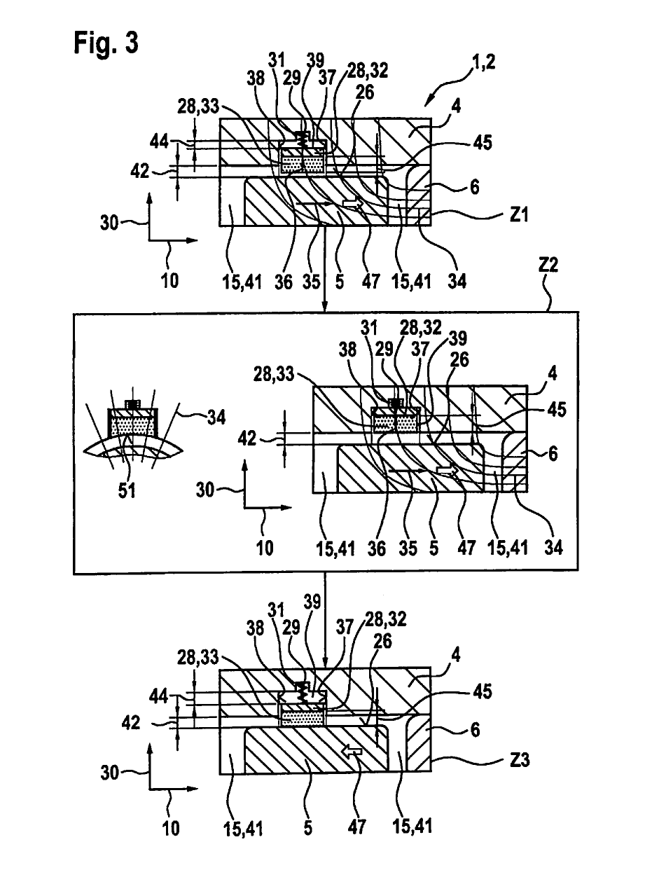

The operating principle of valve 1 according to the first exemplary embodiment during an actuation is explained in greater detail below, also with reference to FIG. 3.

FIG. 3 shows a flow chart for explaining the operating principle of valve 1 according to the first exemplary embodiment. In a state Z1, which preferably occurs shortly after the actuation of armature 5 begins, damping element 28 lifts from outer side 26 of armature 5. As a result, the friction force between damping element 28 and armature 5 ceases, so that a high acceleration of armature 5 is achievable. In a state Z2, damping element 28 is subsequently completely accommodated by grooved indentation 39. An at least essentially unthrottled exchange of the fluid between subchambers 40, 41 is thus possible. This results in high dynamics of armature 5 during the actuation.

In state Z3 solenoid 3 is de-energized, so that the magnetic field depicted by magnetic lines 34 dissipates preferably quickly, and preferably collapses. As a result, force 31 of spring element 29, which is further tensioned in state Z2, is preferably greater than radial magnetic force 36 at a point preferably early during the resetting. During movement 47 of armature 5 opposite opening direction 10, this results initially in hydraulic damping, and then also the friction-based damping, of the movement of armature 5.

For the operating principle explained with reference to the flow chart illustrated in FIG. 3, a gap or distance 44 of damping element 28 from a groove base of grooved indentation 39 in the starting position of damping element 28 according to FIG. 2 is at least as large as radial extension 42 of annular gap 27. Grooved indentation 39 may thus completely accommodate damping element 28 within the scope of the sequence in state Z2 depicted with reference to FIG. 3.

In addition, a material thickness 45 of the paramagnetic material (portion 33) is designed to be greater than distance 44.

In the unenergized, closed state of valve 1, all damping elements 28 thus rest against outer side 26 of armature 5, designed as an outer lateral surface, and at the same time are pressed on by the particular spring element 29. At the start of the energization of solenoid 3, magnetic field formed in annular gap 27 ensures a continuously increasing radial magnetic force 36 on damping elements 28, since magnetically active gap 44 is smaller than material thickness 45 of paramagnetic material 33. As soon as resulting radial magnetic force 36 exceeds elastic force 31 of spring element 29, damping elements 28 begin to move away from armature 5, as depicted with reference to state Z1, and after some time they disappear completely into their grooved indentations 39 in housing part 4, as depicted with reference to state Z2. Armature 5 may thus be accelerated without mechanical friction or throttling of the fluid flowing past, and may thus build up the maximum opening pulse for rapid, robust opening of the valve needle, which takes place during the movement of armature 5 in opening direction 10.

The magnetic field once again dissipates after switch-off. Radial magnetic force 36 on damping elements 28 drops below elastic force 31 of spring elements 29 that acts in each case, and damping elements 28 once again move in the direction of outer side 26 of armature 5. Due to damping elements 28 resting against armature 5, on the one hand armature 5 is mechanically decelerated, and on the other hand annular gap 27 is closed, thus greatly throttling the fluid flowing past.

Significant advantages result from these two effects, as explained above.

Radial extension 42 and distance 44 are each approximately one-half of sum 46 of armature free travel path 23 and lift 24 depicted in FIG. 1. As depicted in state Z2 on the left side of the flow chart in FIG. 3, paramagnetic material (portion) 33 of damping element 28 may have an end-face side 51 that is curved in the shape of a cylindrical surface, and thus concave, with respect to a longitudinal axis 50 (FIG. 1). The curvature of end-face side 51 is adapted to outer side 26 of armature 5 when end-face side 51 is used as a friction surface 51. In addition, due to the curvature of end-face side 51, annular gap 27 is at least essentially opened up when damping element 28 is situated up to the groove base in grooved indentation 39.

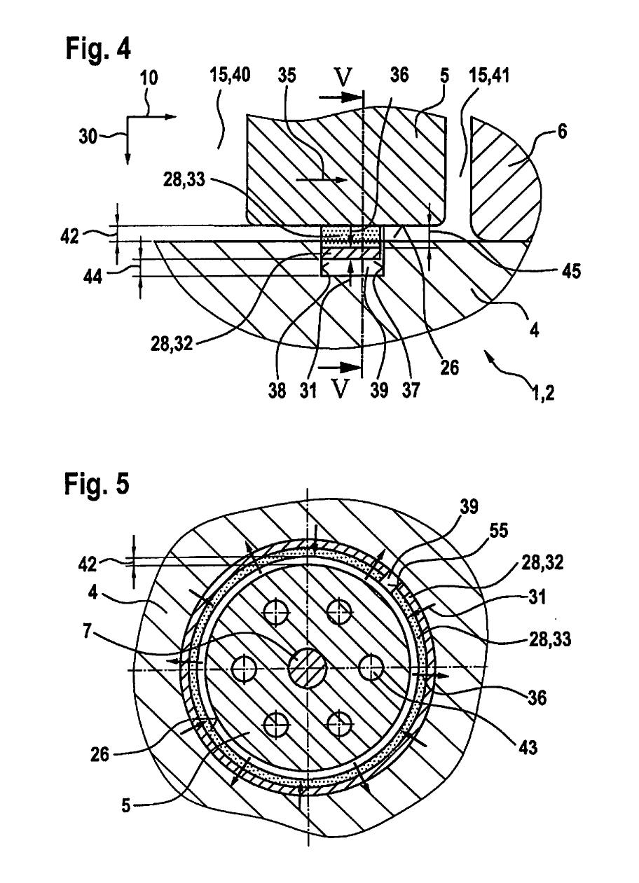

FIG. 4 shows the detail of valve 1 according to a second exemplary embodiment, denoted by reference numeral IV in FIG. 1, in a schematic illustration in a starting state. In this exemplary embodiment, in contrast to the first exemplary embodiment no spring element 29 is necessary. However, in one modified embodiment, at least one spring element 29 may also be provided, which may then have a correspondingly weaker design. In this exemplary embodiment, damping element 28 is designed as a partial ring-shaped damping element.

In this regard, FIG. 5 shows a section of valve 1 according to the second exemplary embodiment, along the section line denoted by reference numeral V in FIG. 4. In this exemplary embodiment, partial ring-shaped damping element 28 is designed as a slotted ring with a slot 55. Elastic force 31 is applied by ring-shaped damping element 28, which is spread apart for assembly on armature 5. Radial magnetic force 36 acts against mechanical force 31.

An actuation by actuator 2 thus causes further spreading of partial ring-shaped damping element 28 via the magnetic field that arises, which eliminates the circumferential contact with outer side 26 of armature 5. In addition, this results in an at least partial sinking of damping element 28 into grooved indentation 39, which is designed as an annular groove 39. This correspondingly enlarges the free cross section of annular gap 27 in the area of damping element 28.

The present invention is not limited to the described exemplary embodiments.

1-10. (canceled)

11. A valve for metering a fluid, comprising:
an electromagnetic actuator;
a valve needle which is actuatable by the actuator and which actuates a valve closing body that cooperates with a valve seat surface to form a sealing seat, an armature of the actuator including a through opening through which the valve needle extends, and an annular gap being formed between an inner wall of a housing part and an outer side of the armature; and
at least one movable damping element situated on the annular gap, the movable damping element being actuatable by a magnetic field that is generated by the actuator.

12. The valve as recited in claim 11, wherein the valve is a fuel injector for an internal combustion engine.

13. The valve as recited in claim 11, wherein the damping element is designed as a damping element that is radially movable.

14. The valve as recited in claim 11, wherein an indentation that is associated with the damping element and at least partially accommodates the damping element is provided in the housing part.

15. The valve as recited in claim 14, further comprising:
at least one spring element associated with the damping element, the spring element at least one of: (i) acting on the damping element in a direction of the outer side of the armature, and (ii) is situated in the indentation.

16. The valve as recited in claim 14, wherein at least one of: (i) the indentation is a grooved indentation, (ii) the damping element is radially guided in the indentation, (iii) the indentation is designed in such a way that the damping element is completely accomodatable by the indentation during an actuation by the magnetic field of the actuator.

17. The valve as recited in claim 11, wherein in an unactuated starting position in which the magnetic field that is generatable by the actuator dissipates, the movable damping element reduces the annular gap to the greatest extent possible, and thereby one of: rests against the outer side of the armature, or is situated at a minimum distance from the outer side of the armature.

18. The valve as recited in claim 11, wherein the damping element is made, at least partially, of at least one ferromagnetic material.

19. The valve as recited in claim 11, wherein the damping element is made partially of at least one paramagnetic material that faces the outer side of the armature.

20. The valve as recited in claim 11, wherein the damping element has a partial ring design, and the partial ring-shaped damping element is designed in such a way that the partial ring-shaped damping element spreads apart along its circumference during the actuation by the magnetic field of the actuator.

21. The valve as recited in claim 11, wherein the movable damping element is actuatable in an opening direction by the magnetic field that is generated by the actuator in order to actuate the valve needle, and the damping element damps the armature for a resetting of the valve needle that takes place opposite the opening direction.
